(19) United States
(12) Patent Application Publication
(10) Pub. No.: US 2018/0133882 A1
(43) Pub. Date: May 17, 2018

(54) HYDRAULIC HAMMER AND SLEEVE THEREFOR

(71) Applicant: Caterpillar Inc., Peoria, IL (US)

(72) Inventors: Cody T. Moore, Waco, TX (US); Dennis W. Tang, Hewitt, TX (US)

(73) Assignee: Caterpillar Inc., Peoria, IL (US)

(21) Appl. No.: 15/352,769

(22) Filed: Nov. 16, 2016

(51) Int. Cl. B25D 17/26; B25D 9/04; B33Y 80/00

(52) U.S. Cl. CPC B25D 17/26; B25D 9/04; B25D 2217/0096; B25D 2217/0019; B33Y 80/00

(57) ABSTRACT

The present disclosure provides a sleeve for a hydraulic hammer. The sleeve includes an elongated body. The elongated body defines an outer surface, an inner surface, and a plurality of axial conduits to transmit hydraulic fluid. The elongated body further defines a plurality of radial holes extending from the plurality of axial conduits to the inner surface of the elongated body. The elongated body also defines a plurality of circumferential grooves on the inner surface. Each of the plurality of circumferential grooves is located along a longitudinal axis of the sleeve. The elongated body also defines at least one micro channel extending radially to form a fluid connection between each of the plurality of axial conduits and each of the plurality of circumferential grooves to transmit the hydraulic fluid for lubrication on the inner surface of the elongated body.

### TECHNICAL FIELD

The present disclosure relates to a hydraulic hammer, and more particularly relates to a sleeve of the hydraulic hammer.

### BACKGROUND

Machines, such as excavators, are provided with hydraulic hammers to break large and hard objects into smaller pieces, thereby assisting in easy disposal of such objects from one location to another. Typically, a hydraulic hammer includes a piston slidably disposed within a sleeve. During the operation of the hydraulic hammer, an inner surface of the sleeve and an outer surface of the piston are subjected to wear due to lack of lubrication on the inner surface of the sleeve.

U.S. Pat. No. 7,628,223 (the '223 patent) describes a rock drilling machine including a sleeve having openings surrounding a portion of a lubrication channel. A groove surrounds the sleeve, and one end of a second channel is connected to the groove. The other end of the second channel is connected to a lubrication point to allow distribution of lubricant from the lubrication channel, through the sleeve and groove, to the second channel, and from the second channel to a lubrication point of the rock drilling machine. The '223 patent requires separate lubricants for the purpose of operating the rock drilling machine and lubrication of the rock drilling machine, which adds to the cost of the rock drilling machine.

### SUMMARY OF THE DISCLOSURE

In one aspect of the present disclosure, a sleeve for a hydraulic hammer is provided. The sleeve includes an elongated body defining an outer surface, an inner surface, and a plurality of axial conduits to transmit hydraulic fluid. The elongated body further defines a plurality of radial holes configured to extend from the plurality of axial conduits to the inner surface of the elongated body. The elongated body also defines a plurality of circumferential grooves on the inner surface. Each of the plurality of circumferential grooves is located along a longitudinal axis of the elongated body. The elongated body also defines at least one micro channel extending radially and configured to form a fluid connection between each of the plurality of axial conduits and each of the plurality of circumferential grooves to transmit the hydraulic fluid for lubrication on the inner surface of the elongated body.

In another aspect of the present disclosure, a hydraulic hammer is provided. The hydraulic hammer includes a piston, an accumulator membrane disposed external and co-axial to the piston, and a sleeve disposed coaxially between the piston and the accumulator membrane. The sleeve includes an elongated body defining an outer surface, an inner surface, and a plurality of axial conduits configured to transmit hydraulic fluid. The elongated body further defines a plurality of radial holes configured to extend from the plurality of axial conduits to the inner surface of the elongated body, and a plurality of circumferential grooves on the inner surface. Each of the plurality of circumferential grooves is located along a longitudinal axis of the elongated body. The elongated body also defines at least one micro channel extending radially and configured to form a fluid connection between each of the plurality of axial conduits and each of the plurality of circumferential grooves to transmit the hydraulic fluid for lubricating the piston. The hydraulic hammer also includes a valve member disposed coaxially between the sleeve and the piston.

In yet another aspect of the present disclosure, a method for lubricating an inner surface of a sleeve of a hydraulic hammer is provided. The method includes fluidly communicating the inner surface of the sleeve with a plurality of axial conduits, via a plurality of radial holes, for supplying hydraulic fluid to the inner surface of the sleeve. The method further includes fluidly communicating the plurality of axial conduits with a plurality of circumferential grooves defined on the inner surface of the sleeve, via at least one micro channel, for lubricating the inner surface of the sleeve. The method also includes draining the hydraulic fluid from the inner surface of the sleeve via a vent passage defined in a wall of the sleeve. The vent passage is in fluid communication with a reservoir.

Other features and aspects of this disclosure will be apparent from the following description and the accompanying drawings.

### BRIEF DESCRIPTION OF THE DRAWINGS

FIG. 1 is a cross-sectional view of a portion of a hydraulic hammer, according to an embodiment of the present disclosure;

FIG. 2 is a sectional view of a sleeve of the hydraulic hammer, according to an embodiment of the present disclosure;

FIG. 3 is a cross-sectional view of the sleeve taken along a section line S-S′ of FIG. 2, according to an embodiment of the present disclosure;

FIG. 4A is an enlarged view of a portion ‘M’ of the hydraulic hammer of FIG. 1 showing a first position of a piston of the hydraulic hammer, according to an embodiment of the present disclosure;

FIG. 4B is an enlarged view of the portion ‘M’ showing a second position of the piston, according to an embodiment of the present disclosure;

FIG. 5A is an enlarged view of a portion ‘N’ of the hydraulic hammer of FIG. 4A showing a first position of a valve member of the hydraulic hammer, according to an embodiment of the present disclosure;

FIG. 5B is an enlarged view the portion ‘N’ showing a second position of the valve member, according to an embodiment of the present disclosure;

FIG. 6 is a portion of the hydraulic hammer of FIG. 1, according to an embodiment of the present disclosure;

FIG. 7 is a flowchart of a method for lubricating an inner surface of the sleeve of the hydraulic hammer, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims. No element, act, or instruction used herein should be construed as critical or essential unless explicitly described as such. Also, as used herein, the articles “a” and “an” are intended to include one or more items, and may be used interchangeably with “one or more”. Furthermore, as used herein, the term “set” is intended to include one or more items, and may be used interchangeably with “one or more”.

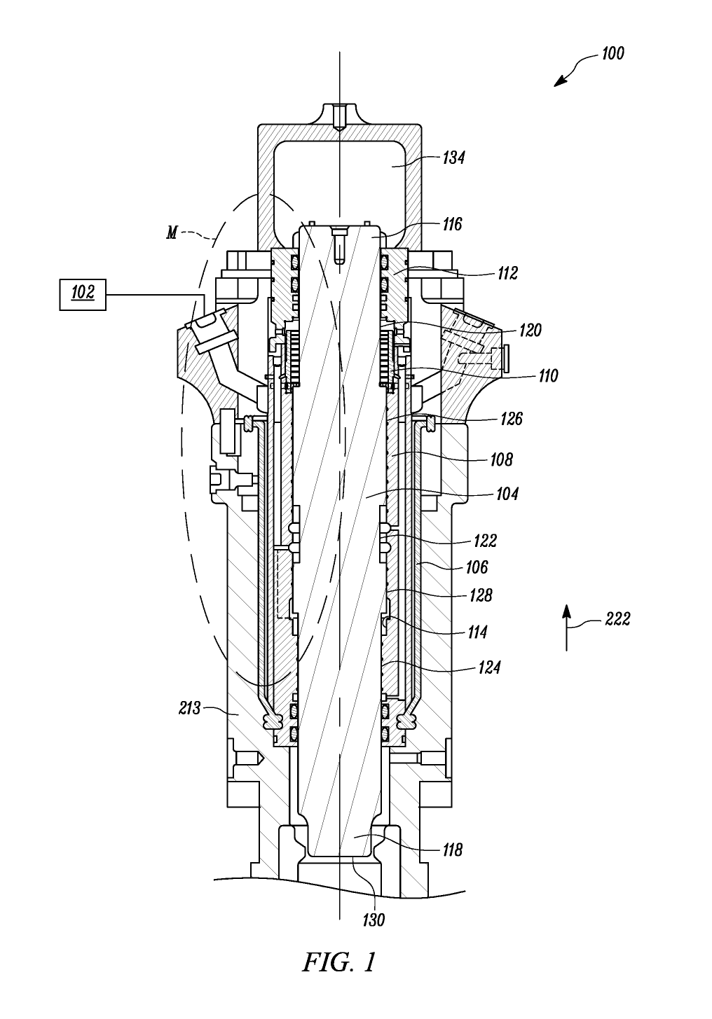

Referring to FIG. 1, a cross-sectional view of a portion of a hydraulic hammer 100 is illustrated. The hydraulic hammer 100 is pivotally connected to a machine (not shown). In an example, the machine may be an excavator. In case of the excavator, the hydraulic hammer 100 may be pivotally connected to a boom assembly. More specifically, the hydraulic hammer 100 may be coupled to a stick of the boom assembly. Further, the hydraulic hammer 100 may be fluidly communicated with a hydraulic system (not shown) of the machine to receive hydraulic fluid. Supplied hydraulic fluid may be used to operate the hydraulic hammer 100 and hence to break large and hard objects into smaller pieces. In particular, the hydraulic hammer 100 is connected to a pump 102 of the hydraulic system to receive pressurized hydraulic fluid.

The hydraulic hammer 100 includes a piston 104, an accumulator membrane 106 disposed external and co-axial to the piston 104, a sleeve 108 disposed coaxially between the piston 104 and the accumulator membrane 106, a valve member 110 partially received within the sleeve 108, and a head member 112 partially enclosing the valve member 110. In one embodiment, the accumulator membrane 106 may be made from an elastic material, for example a synthetic rubber.

The piston 104 is slidably disposed in a bore 114 of the sleeve 108. The piston 104 includes a first end 116 and a second end 118 defining a length of the piston 104. In one embodiment, the piston 104 includes varying diameters along the length thereof, for example one or more narrow diameter sections defined axially between wider diameter sections. As shown in FIG. 1, the piston 104 includes three narrow diameter sections 120, 122, and 124 separated by two wide diameter sections 126, and 128. The narrow diameter sections 120, 122, and 124 are designed to selectively open and close multiple conduits defined within the sleeve 108 during the movement of the piston 104 within the bore 114. Further, the valve member 110 is disposed proximal to the first end 116 of the piston 104 and is located radially inward of the sleeve 108 and the head member 112. A portion of the head member 112 axially overlaps with the sleeve 108. The hydraulic hammer 100 also includes a gas chamber 134 partially enclosing the first end 116 of the piston 104. The gas chamber 134 is charged with pressurized compressible gas, such as nitrogen.

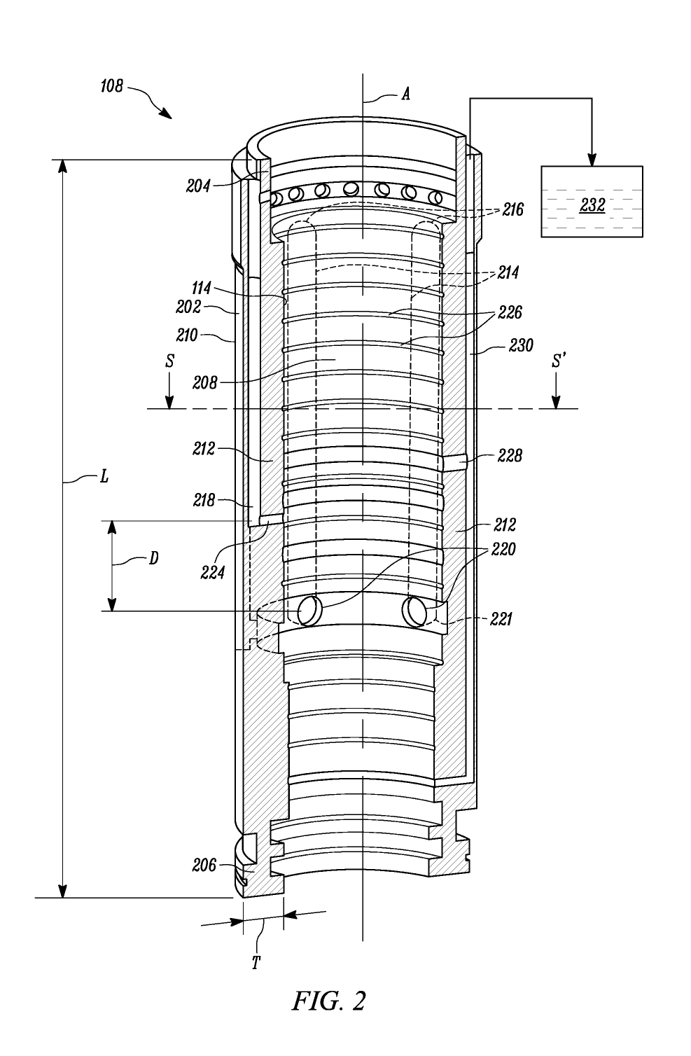

Referring to FIG. 2, a cross-sectional view of the sleeve 108, according to an embodiment of the present disclosure, is illustrated. Various aspects of FIG. 2 are described in conjunction with FIG. 1 of the present disclosure. The sleeve 108 includes an elongated body 202, hereinafter referred to as “the body 202”, having a first end 204 overlapping with the head member 112 and a second end 206 distant from the first end 204. The body 202 is provided as a cylindrical tube having an axial length ‘L’ greater than a length of the accumulator membrane 106. The body 202 defines an inner surface 208 and an outer surface 210, which together define a thickness ‘T’ of a wall 212 of the sleeve 108. The inner surface 208 and the outer surface 210 of the body 202 are alternatively referred to as the inner surface 208 and the outer surface 210 of the sleeve 108. The thickness ‘T’ of the wall 212 may be predetermined, so that the sleeve 108, the accumulator membrane 106, the valve member 110, and the piston 104 can be accommodated within a housing 213 in a coaxial arrangement. The sleeve 108 includes varying diameter sections along the axial length as shown in FIG. 2.

The body 202 also defines multiple axial conduits to transmit the hydraulic fluid to the inner surface 208 of the sleeve 108. The axial conduits extend along a longitudinal axis ‘A’ of the sleeve 108. In one embodiment, the multiple axial conduits include a first set of conduits 214 extending along the longitudinal axis ‘A’ of the sleeve 108. For the purpose of description, each conduit of the first set of conduits 214 is referred to as ‘the conduit 214’. Each of the first set of conduits 214 may be formed in the wall 212 of the sleeve 108. A first end 216 of each conduit 214 receives the hydraulic fluid from the pump 102.

The axial conduits also include at least one second conduit 218, which extends along the longitudinal axis ‘A’ of the sleeve 108. The second conduit 218 is also defined within the wall 212 of the body 202 and located between two conduits 214 of the first set of conduits 214. Diameter of the second conduit 218 may be less than diameter of each conduit 214 of the first set of conduits 214.

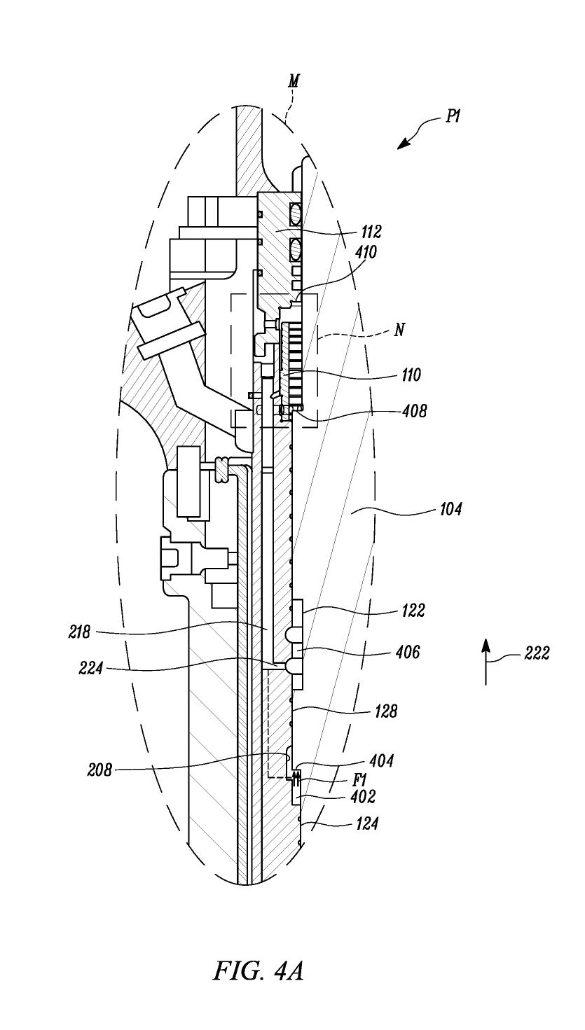

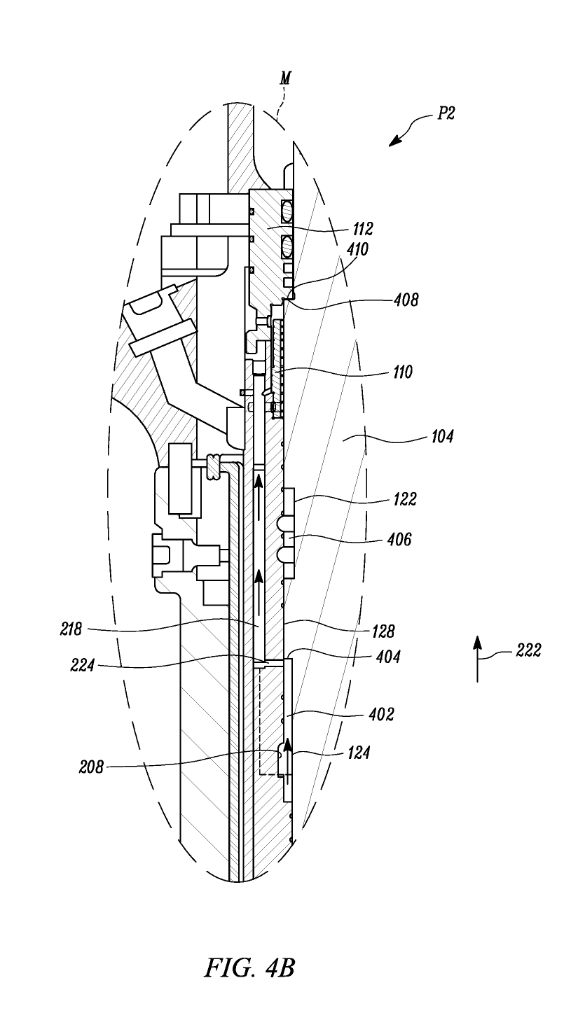

Multiple radial holes are also formed in the body 202 to extend from the first set of conduits 214 to the inner surface 208 of the sleeve 108. A set of first radial holes 220 of the multiple radial holes is located at a second end 221 of the conduits 214 and are proximal to the second end 206 of the body 202. Each first radial hole 220 (as shown in FIG. 2) of the set of first radial holes 220 extends from one conduit 214 of the first set of conduits 214 to the inner surface 208 of the sleeve 108. Therefore, each conduit 214 is in fluid communication with one first radial hole 220. As such, the hydraulic fluid received into the conduit 214 flows into the bore 114 of the sleeve 108 via the first radial hole 220, at a location proximal to the second end 118 of the piston 104. The hydraulic fluid received into the bore 114 causes an upward movement (indicated by arrow 222 in FIG. 1) of the piston 104, which is described later with reference to FIG. 4A and FIG. 4B.

The body 202 also defines at least one second radial hole 224 in the wall 212 of the body 202. The second radial hole 224 of the multiple radial holes is located at a distance ‘D’ from the set of first radial holes 220 along the longitudinal axis ‘A’ of the sleeve 108, as shown in FIG. 2. In an example, periphery of each first radial hole 220 and the second radial hole 224 may define a circle. Diameter of the second radial hole 224 may be less than diameter of each first radial hole 220. The second radial hole 224 extends from the second conduit 218 to the inner surface 208 of the sleeve 108. Therefore, the second conduit 218 is in fluid communication with the second radial hole 224. The hydraulic fluid present in the bore 114 of the sleeve 108 enters the second conduit 218, via the second radial hole 224, during the upward movement of the piston 104.

The body 202 also defines multiple circumferential grooves 226 on the inner surface 208 throughout the axial length ‘L’ and along the longitudinal axis ‘A’ of the sleeve 108. In an example, each circumferential groove 226 may be defined as V-shaped or C-shaped grooves. In one embodiment, distance between two consecutive circumferential grooves 226 may be in a range of 10 to 12 millimeters (mm).

The body 202 of the sleeve 108 also defines at least one vent hole 228 and a vent passage 230 in the wall 212. The vent hole 228 extends radially from the inner surface 208 of the sleeve 108 to form a fluid connection between the inner surface 208 of the sleeve 108 and the vent passage 230. The vent hole 228 and the vent passage 230 receive the hydraulic fluid from the bore 114 and allow flow of the hydraulic fluid to a reservoir 232 of the hydraulic system.

In the illustrated embodiment, the sleeve 108 is manufactured as a single component using a Three Dimensional (3D) printing process. In an example, manufacturing of the sleeve 108 using the 3D printing process may involve a 3D printing machine and a software module in communication with the 3D printing machine. The software module may include a CAD model of the sleeve 108. Various dimensional aspects, such as an inner diameter defined by the inner surface 208, varying diameter sections of the body 202, length and width of axial conduits, and diameters of the multiple radial holes, may be precisely and accurately included in the CAD model. Based on the CAD model, the 3D printing machine may deposit material in multiple layers one above another to form the sleeve 108.

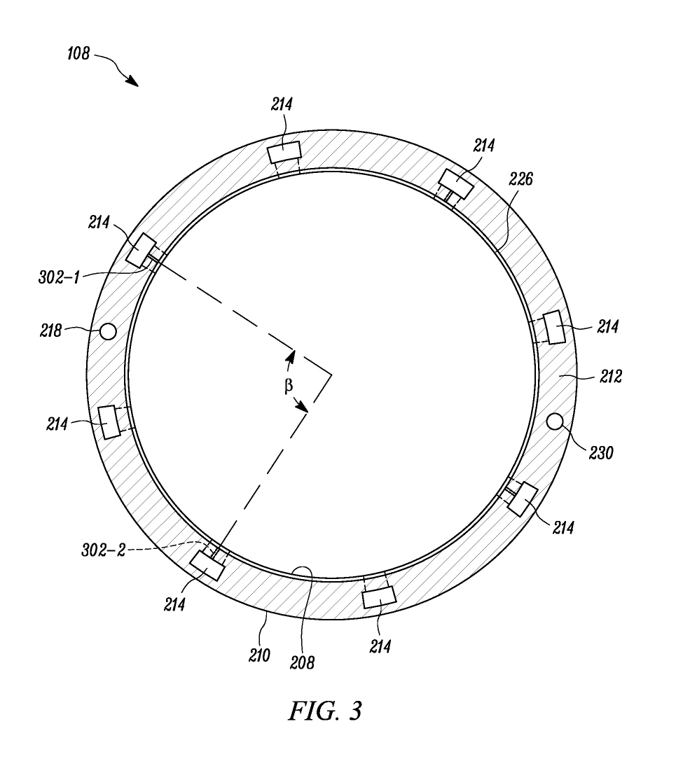

Referring to FIG. 3, a cross-sectional view of the sleeve 108 taken along a section line S-S′ in FIG. 2 is illustrated. In particular, the section line S-S′ is considered across one circumferential groove 226. In one embodiment, the body 202 further defines at least one micro channel extending radially to form a fluid connection between each conduit 214 of the first set of conduits 214 and the circumferential grooves 226. For example, a first micro channel 302-1 forms a fluid connection between the conduit 214 and the circumferential groove 226. As such, the hydraulic fluid flowing through the conduit 214 also flows through the first micro channel 302-1 and further into the bore 114 of the sleeve 108. Therefore, the micro channel aids in transmitting the hydraulic fluid from the axial conduits for lubrication on the inner surface 208 of the sleeve 108.

The first micro channel 302-1 of one circumferential groove 226 is located at a predetermined angle ‘β’ with respect to location of a second micro channel 302-2 of a subsequent circumferential groove 226. In an example, the predetermined angle ‘β’ may be about 90 degrees. Each circumferential groove 226 may include one ore more micro channels to form fluid connection between the set of first conduits 214 and the circumferential groove 226, as shown in FIG. 3. Further, cross-section of the at least one micro channel may be one of a circle, a square, and a polygon. In an example, diameter of the at least one micro channel may be about 0.1 mm. Although the at least one micro channel is illustrated as a straight channel, the at least one micro channel may also be provided with arcuate configuration or zig-zag configuration to regulate pressure of the hydraulic fluid entering the at least one micro channel. For the brevity in description, only the first micro channel 302-1 and the second micro channel 302-2 are described and illustrated in FIG. 3. However, it should be understood that the body 202 can include multiple micro channels formed in the circumferential grooves 226. In one embodiment, the micro channel 302-1 and 302-2 may extend from the vent passage 208 to the inner surface 208 of the sleeve 108, so that the vented hydraulic fluid can be used to lubricate the inner surface 208 of the sleeve 108.

Operation of the hydraulic hammer 100, according to the embodiments of the present disclosure, is described hereinafter. FIG. 4A and FIG. 4B illustrate enlarged portions of the hydraulic hammer 100 showing different positions of the piston 104 during the upward movement (indicated by arrow 222). Various aspects of FIG. 4A and FIG. 4B are described in conjunction with FIG. 1 to FIG. 3. FIG. 4A illustrates the enlarged portion ‘M’ of the hydraulic hammer 100 showing a first position ‘P1’ of the piston 104. In operation, pressurized hydraulic fluid supplied by the pump 102 flows into the bore 114 of the sleeve 108 via the first radial hole 220. As shown in FIG. 4A, the first radial hole 220 opens into a first circumferential chamber 402 defined by the narrow diameter section 124 of the piston 104 and the inner surface 208 of the sleeve 108. Accumulation of the hydraulic fluid in the first circumferential chamber 402 develops pressure and applies thrust on a first neck portion 404, indicated by arrows F1. Although FIG. 4A illustrates only a portion of the first circumferential chamber 402, it should be understood that the hydraulic fluid is received from other first radial holes 220 located along circumference of the sleeve 108. As such, equal amounts of the hydraulic fluid would be received in the first circumferential chamber 402, thereby applying equal magnitude of thrust all along the first neck portion 404.

In the first position ‘P1’ of the piston 104, the wide diameter section 128 of the piston 104 restricts escape of the hydraulic fluid from the first circumferential chamber 402 to the second conduit 218. The narrow diameter section 122 of the piston 104 defines a second circumferential chamber 406 with the inner surface 208 of the sleeve 108. Micro channels 302-1 and 302-2 of the circumferential grooves 226 simultaneously allow the hydraulic fluid to leak through the wall 212 of the sleeve 108. The leaked hydraulic fluid assists in lubricating the inner surface 208 of the sleeve 108. Similarly, other micro channels of the sleeve 108 allow lubrication of other portions of the inner surface 208 of the sleeve 108 which are not illustrated in the figures.

Application of thrust by the hydraulic fluid on the first neck portion 404 causes the piston 104 to displace from the first position ‘P1’ to a second position ‘P2’, shown in FIG. 4B. In the second position ‘P2’, the piston 104 remains displaced in the upward direction along the longitudinal axis ‘A’ of the sleeve 108. The first end 116 of the piston 104 extends into the gas chamber 134 during movement of the piston 104 from the first position ‘P1’ to the second position ‘P2’. Extension of the first end 116 of the piston 104 into the gas chamber 134 is limited by a second neck portion 408. That is, the first end 116 of the piston 104 can extend into the gas chamber 134 until the second neck portion 408 contacts a seat portion 410 defined in the head member 112 of the hydraulic hammer 100.

In the second position ‘P2’, the narrow diameter section 124 approaches the second radial hole 224. As such, the hydraulic fluid accumulated in the first circumferential chamber 402 is allowed to flow through the second conduit 218. Also, volume of the first circumferential chamber 402 increases (shown in FIG. 4B) gradually as the piston 104 moves from the first position ‘P1’ to the second position ‘P2’. Therefore, pressure of the hydraulic fluid decreases when the hydraulic fluid flows from the first circumferential chamber 402 to the second conduit 218. Due to subsequent flow of pressurized hydraulic fluid into the first circumferential chamber 402 from the conduit 214, the hydraulic fluid is forced to rise in the second conduit 218 and reach the valve member 110.

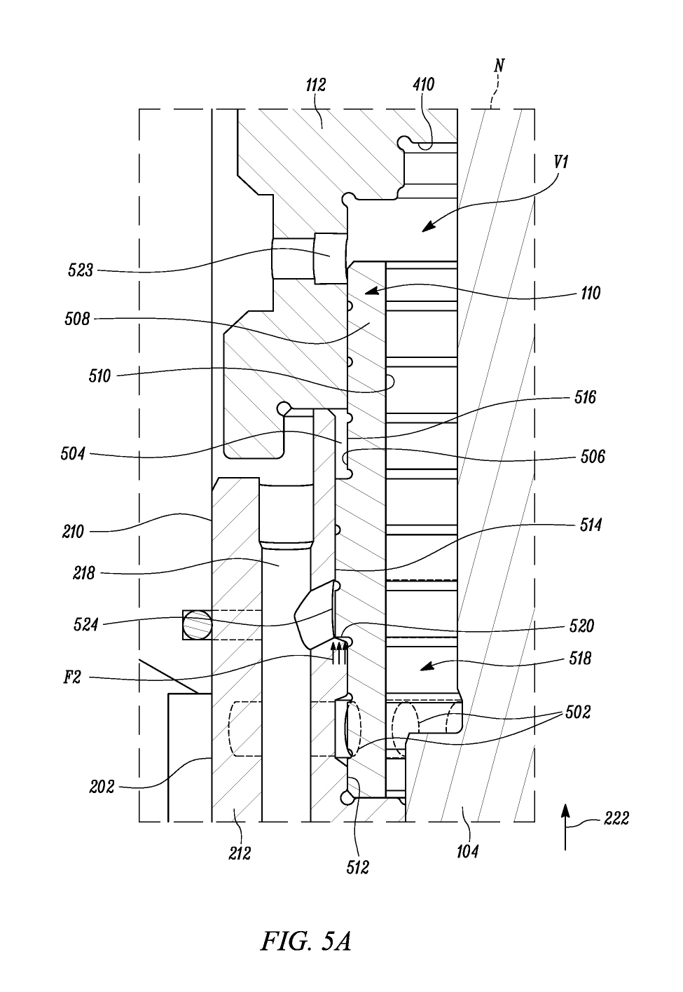

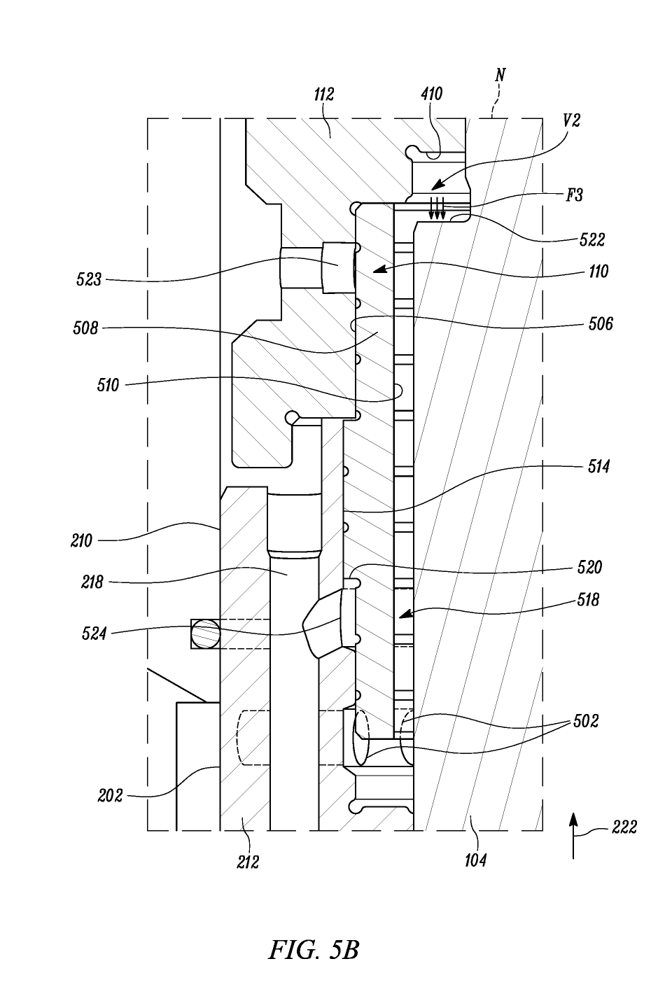

FIG. 5A and FIG. 5B illustrate an enlarged portion ‘N’ (refer FIG. 4A) of the hydraulic hammer 100 showing different positions of the valve member 110 during movement of the piston 104 from the first position ‘P1’ to the second position ‘P2’. Referring to FIG. 5A, the body 202 defines a set of third radial holes 502 extending across the wall 212 of the body 202 to form fluid connection between the outer surface 210 of the body 202 and the inner surface 208 of the body 202. The pressurized hydraulic fluid from the pump 102 is also supplied through each radial hole of the set of third radial holes 502. Further, the inner surface 208 of the sleeve 108 and the piston 104 defines a cavity 504 therebetween to receive the valve member 110. As described with respect to FIG. 1, the valve member 110 is disposed coaxially between the sleeve 108 and the piston 104.

Diameter of the valve member 110 is predetermined, so that the valve member 110 may be accommodated in the cavity 504, such that an outer surface 506 of the valve member 110 is disposed in close proximity to the inner surface 208 of the body 202 of the sleeve 108. In an embodiment, the valve member 110 may be slidably disposed within the cavity 504. The valve member 110 includes varying diameter sections, such as a first section 512, a second section 514, and a third section 516. A wall 508 of the valve member 110 includes an inner surface 510, which defines a third circumferential chamber 518 with the piston 104.

The pressurized hydraulic fluid entering the cavity 504 via the set of third radial holes 502 seeps along the outer surface 506 of the first section 512 of the valve member 110 and causes development of thrust (indicated through arrows F2) on a third neck portion 520 of the valve member 110, as shown in FIG. 5A. The thrust causes the valve member 110 to slide in the upward direction (indicated by arrow 222) from a first position ‘V1’ to a second position ‘V2’.

As the valve member 110 gets displaced from the first position ‘V1’, the set of third radial holes 502 fluidly connect with the third circumferential chamber 518. As such, the pressurized hydraulic fluid flows through the third circumferential chamber 518 and towards the seat portion 410. The hydraulic fluid occupying a confined space at the seat portion 410 causes application of thrust (indicated by arrows F3) on a fourth neck portion 522 located on the piston 104. Displacement of the valve member 110 from the first position ‘V1’ causes a vent port 523 of the head member 112 to be gradually covered by the valve member 110. However, prior to being covered completely, the vent port 523 aids in venting any hydraulic fluid which would have occupied the confined space at the seat portion 410.

In parallel, a connecting port 524 of the second conduit 218 is uncovered by the second section 514 of the valve member 110 and, therefore, the hydraulic fluid flows from the second conduit 218 to the cavity 504. The hydraulic fluid from the second radial hole 224 adds to the thrust already being applied on the third neck portion 520, thereby displacing the valve member 110 further in the upward direction to the second position ‘V2’.

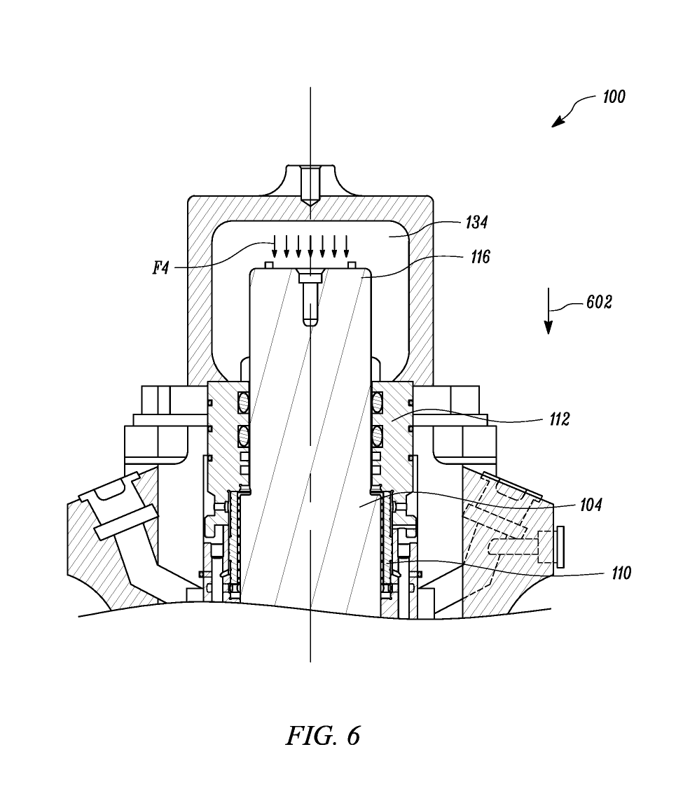

Simultaneously, as described earlier, the first end 116 of the piston 104 extends into the gas chamber 134, as illustrated in FIG. 6. Effective volume of the gas chamber 134 gradually decreases as the first end 116 of the piston 104 enters and extends into the gas chamber 134. The decrease in volume of the gas chamber 134 causes development of pressure within the gas chamber 134, thereby causing application of thrust (indicated by F4) on the first end 116 of the piston 104. The thrust applied on the fourth neck portion 522 adds to the thrust applied on the first end 116 of the piston 104, to cause the piston 104 to slide from the second position ‘P2’ to the first position ‘P1’ in a downward direction (indicated by arrow 602). The combined thrust causes the piston 104 to provide an impact force on the work tool. The operation repeats in multiple cycles and causes the piston 104 to reciprocate between the first position ‘P1’ and the second position ‘P2’.

Various embodiments disclosed herein are to be taken in the illustrative and explanatory sense, and should in no way be construed as limitations to the present disclosure.

### INDUSTRIAL APPLICABILITY

Embodiments of the present disclosure pertain to the sleeve 108 of the hydraulic hammer 100. As described earlier, the sleeve 108 is manufactured using the 3D printing process. The 3D printed sleeve 108 is formed as a single component, as opposed to conventional sleeves which include a body and a sleeve liner surrounding the body. The 3D printed sleeve minimizes cost of manufacture of the sleeve 108, while also overcoming requirement of an additional sleeve liner.

Further, the sleeve 108 includes multiple circumferential grooves 226, where each circumferential groove 226 includes at least one micro channel 302-1 and 302-2. Since the micro channels 302-1 and 302-2 extend between the axial conduits, such as the first set of conduits 214, and the inner surface 208 of the sleeve 108, the hydraulic fluid flowing through the axial conduits are allowed to flow through the micro channels 302-1 and 302-2. As such, the micro channels 302-1 and 302-2 constitute a leak path for the hydraulic fluid through the wall 212 of the sleeve 108, thereby lubricating the inner surface 208 of the sleeve 108. Presence of the hydraulic fluid on the inner surface 208 of the sleeve 108 minimizes or eliminates possibility of wear between the piston 104 and the inner surface 208 of the sleeve 108. Therefore, the sleeve 108 of the present disclosure increases life of the piston 104 and the life of the hydraulic hammer 100.

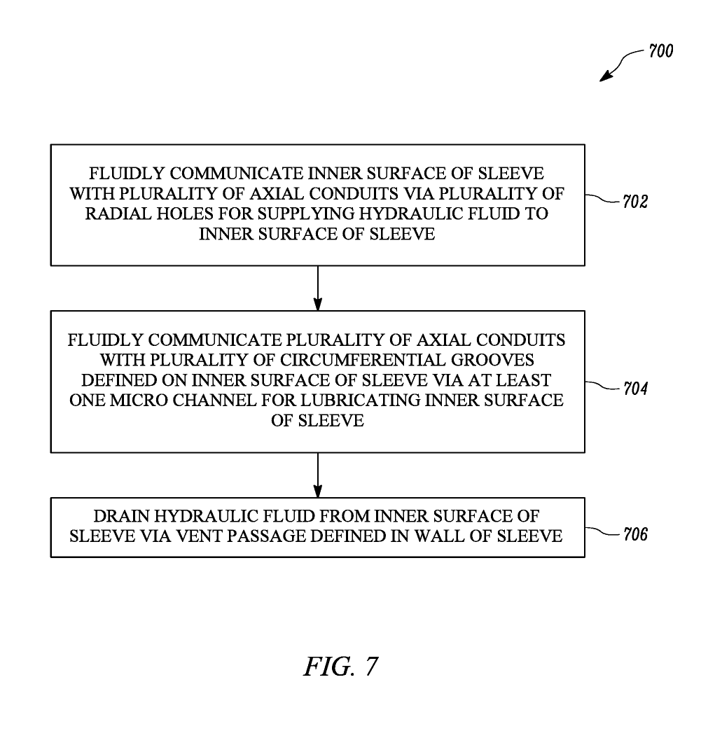

The present disclosure also provides a method 700 for lubricating the inner surface 208 of the sleeve 108 of the hydraulic hammer 100. In particular, FIG. 7 illustrates a flowchart of the method 700, according to an embodiment of the present disclosure. The flowchart includes blocks, where each block recites a step of the method 700. The steps in which the method 700 are described are not intended to be construed as a limitation, and any number of steps can be combined in any order to implement the method 700.

Various steps of the method 700 are described in conjunction with FIG. 1 to FIG. 6 of the present disclosure. As illustrated in FIG. 7, at step 702, the method 700 includes fluidly communicating the inner surface 208 of the sleeve 108 with plurality of axial conduits via plurality of radial holes for supplying the hydraulic fluid to the inner surface 208 of the sleeve 108. The plurality of radial holes includes a set of first radial holes 220 and at least one second radial hole 224 which extend from the first set of conduits 214 and the second conduit 218, respectively, to the inner surface 208 of the sleeve 108. The hydraulic fluid flowing in the conduits 214 enter the bore 114 via the set of first radial holes 220.

At step 704, the method 700 includes fluidly communicating the plurality of axial conduits with the plurality of circumferential grooves 226 defined on the inner surface 208 of the sleeve 108, via at least one micro channel for lubricating the inner surface 208 of the sleeve 108. The micro channel 302-1 and 302-2 extend between the plurality of axial conduits and the plurality of circumferential grooves 226, thereby forming a fluid connecting between the plurality of axial conduits and the plurality of circumferential grooves 226. The micro channel 302-1 and 302-2 form the leak path for the hydraulic fluid for lubricating the inner surface 208 of the sleeve 108.

At step 706, the method 700 includes draining the hydraulic fluid from the inner surface 208 of the sleeve 108 via the vent passage 230 defined in the wall 212 of the sleeve 108. The vent passage 230 is in fluid communication with the reservoir 232.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A sleeve for a hydraulic hammer, the sleeve comprising:
an elongated body defining:
an outer surface;
an inner surface;
a plurality of axial conduits configured to transmit hydraulic fluid;
a plurality of radial holes configured to extend from the plurality of axial conduits to the inner surface of the elongated body;
a plurality of circumferential grooves on the inner surface, each of the plurality of circumferential grooves located along a longitudinal axis of the elongated body; and
at least one micro channel extending radially and configured to form a fluid connection between each of the plurality of axial conduits and each of the plurality of circumferential grooves to transmit the hydraulic fluid for lubrication on the inner surface of the elongated body.

2. The sleeve of claim 1, wherein the sleeve is a three-dimensional printed sleeve.

3. The sleeve of claim 1, wherein the plurality of axial conduits comprises a first set of conduits extending along the longitudinal axis of the sleeve, and wherein each conduit of the first set of conduits is in fluid communication with one radial hole of the set of first radial holes.

4. The sleeve of claim 1, wherein the plurality of axial conduits comprises at least one second conduit extending along the longitudinal axis of the sleeve, and wherein the at least one second conduit is in fluid communication with at least one second radial hole of the plurality of radial holes and configured to receive hydraulic fluid from a bore of the sleeve.

5. The sleeve of claim 1, wherein the micro channel of one circumferential groove is located at about 90 degrees with respect to location of the micro channel of a subsequent circumferential groove.

6. The sleeve of claim 1, wherein distance between two consecutive circumferential grooves on the inner surface of the sleeve is in a range of 10 to 12 millimeters (mm).

7. The sleeve of claim 1, wherein cross-section of the at least one micro channel is one of a circle, a square, and a polygon.

8. The sleeve of claim 1, wherein diameter of the at least one micro channel is about 0.1 mm.

9. The sleeve of claim 1, wherein the sleeve defines at least one vent hole extending radially and configured to form a fluid connection between the inner surface of the sleeve and a vent passage defined in the elongated body.

10. A hydraulic hammer comprising:
a piston;
an accumulator membrane disposed external and co-axial to the piston; and
a sleeve disposed coaxially between the piston and the accumulator membrane, the sleeve comprising:
an elongated body defining:
an outer surface;
an inner surface;
a plurality of axial conduits configured to transmit hydraulic fluid;
a plurality of radial holes configured to extend from the plurality of axial conduits to the inner surface of the sleeve;
a plurality of circumferential grooves on the inner surface, each of the plurality of circumferential grooves located along a longitudinal axis of the elongated body; and
at least one micro channel extending radially and configured to form a fluid connection between each of the plurality of axial conduits and each of the plurality of circumferential grooves to transmit hydraulic fluid for lubricating the piston; and
a valve member slidably disposed coaxially between the sleeve and the piston.

11. The hydraulic hammer of claim 10, wherein the sleeve is a three-dimensional printed sleeve.

12. The hydraulic hammer of claim 10, wherein the micro channel of one circumferential groove is located at about 90 degrees with respect to location of the micro channel of a subsequent circumferential groove.

13. The hydraulic hammer of claim 10, wherein distance between two consecutive circumferential grooves on the inner surface of the sleeve is in a range of 10 to 12 mm.

14. The hydraulic hammer of claim 10, wherein cross-section of the at least one micro channel is one of a circle, a square, and a polygon.

15. The hydraulic hammer of claim 10, wherein diameter of the at least micro channel is about 0.1 mm.

16. The hydraulic hammer of claim 10, wherein the sleeve partially encloses the valve member.

17. A method for lubricating an inner surface of a sleeve of a hydraulic hammer, the method comprising:
fluidly communicating the inner surface of the sleeve with a plurality of axial conduits, via a plurality of radial holes, for supplying hydraulic fluid to the inner surface of the sleeve;
fluidly communicating the plurality of axial conduits with a plurality of circumferential grooves defined on the inner surface of the sleeve, via at least one micro channel, for lubricating the inner surface of the sleeve; and
draining the hydraulic fluid from the inner surface of the sleeve via a vent passage defined in a wall of the sleeve, wherein the vent passage is in fluid communication with a reservoir.
